(19) United States
(12) Patent Application Publication
(10) Pub. No.: US 2023/0263324 A1
(43) Pub. Date: Aug. 24, 2023

(54) FOOD-SAFE STRAW AND METHOD FOR MAKING IT

(71) Applicant: G.D S.p.A., Bologna (IT)

(72) Inventors: Nicola BALDANZA, Bologna (IT); Ivan EUSEPI, Bologna (IT); Giuliano GAMBERINI, Bologna (IT)

(21) Appl. No.: 18/006,692

(22) PCT Filed: Jul. 28, 2021
(86) PCT No.: PCT/IB2021/056846

§ 371 Date: Jan. 24, 2023

(30) Foreign Application Priority Data
Aug. 11, 2020 (IT) 102020000019942

(51) Int. Cl. A47G 21/18; B31D 5/00

(52) U.S. Cl. CPC A47G 21/18; B31D 5/0095; A47G 2400/10

(57) ABSTRACT

A food-safe paper straw, including an outer tubular element made of paper material which extends along a longitudinal axis and a longitudinal insert made of paper material positioned inside the outer tubular element and stably connected to an inner surface of the outer tubular element, said insert having a profile, in transversal cross section, defined by a line at least partly corrugated and/or partly broken in such a way as to increase the bending strength of the straw, wherein said insert is stably connected to the inner surface of the outer tubular element in at least two connecting zones, preferably at least three connecting zones, angularly spaced from each other about said longitudinal axis.

### TECHNICAL FIELD

This invention relates to a food-safe straw and to a method for making it. In particular, the straw according to the invention is obtained by folding and/or wrapping paper material and is therefore of a type that complies with stringent waste disposal regulations.

More specifically, the invention refers to a straw that has enhanced flexural rigidity, making it also suitable for mixing liquid or semi-liquid products (beverages, granitas, fruit shakes, milk shakes and more).

### BACKGROUND ART

Known at the present time are straws made of paper material, obtained from a web or sheet of paper material. These have very good environmental properties (easy waste disposal) but low rigidity properties, which means they cannot be effectively used for mixing semi-liquid or thick products because they tend to bend or break, thus becoming totally useless.

Also known are straws made from plastic material, obtained by extrusion. These are more rigid than paper straws but less environmentally friendly and in some cases, they are also not rigid enough for use with semi-liquid or thick products.

### AIM OF THE INVENTION

In this context, the basic technical purpose of this invention is to provide a food-safe straw and a method for making it, to overcome the above mentioned disadvantages of the prior art.

In particular, this invention has for an aim to provide a food-safe straw that can be used to consume semi-liquid or thick products, allowing them to be mixed without being bent or twisted out of shape or breaking.

Another aim of this invention is to provide a food-safe straw which complies with current waste disposal regulations, hence minimizing its environmental impact.

The technical purpose indicated and the aims specified are substantially achieved by a food-safe straw and a related method comprising the technical features described in claims 1 and 18 and/or in one or more of the claims dependent thereon.

According to the invention, the straw comprises an outer tubular element and a longitudinal insert placed inside the outer tubular element and defining an element for enhancing the bending strength of the straw along at least one direction, preferably along two directions that are perpendicular to each other.

The outer tubular element is made of paper material and extends along a longitudinal axis defining the main axis of extension and/or substantial symmetry of the straw. Preferably, the insert extends along the longitudinal axis for a length corresponding to the length of the outer tubular element. The length is preferably between 6 and 30 cm.

The longitudinal insert is also made of paper material and is connected stably to an inner surface of the outer tubular element.

Advantageously, the insert has a profile whose shape, in transversal cross section, is defined by a line that is at least partly corrugated and/or partly broken in such a way as to increase the bending strength of the straw. Preferably, this profile shape is three-dimensional and not circular.

According to the invention, the outer layer is not necessarily the outermost layer but a layer that is on the outside of the insert. For example, the outer layer might be an intermediate layer that is in turn covered by another layer on the outside of it.

Preferably, the insert is connected stably to the inner surface of the outer tubular element in at least two zones, more preferably in at least three zones which are angularly spaced from each other around the longitudinal axis. These connecting zones preferably extend along the full length of the straw.

In a preferred embodiment, the connecting zones are spaced from each other by intermediate portions of the insert that extend towards the longitudinal axis, preferably uninterruptedly.

In an embodiment, the connecting zones define a main portion of the surface of the insert, preferably a portion of between 50% and 80% of the surface of the insert.

In an embodiment, the intermediate zones define a main portion of the surface of the insert, preferably a portion of between 50% and 80% of the surface of the insert.

In an embodiment, the shape of the insert, in transversal cross section, extends along a curved profile, preferably without edges and/or rectilinear portions. In this solution, the connecting zones are defined by tangential zones between the insert and the outer tubular element.

In an embodiment, the insert has a corrugated profile, in transversal cross section, having a succession of top portions, defining the connecting portions, alternated with bottom portions, facing towards the longitudinal axis. In this solution, the straw may comprise (but not necessarily) an additional inner covering layer that is stably connected to the bottom portions and thus defines a smaller diameter region of the straw.

In an alternative embodiment, the connecting portions have a curvature that is substantially concentric with the outer tubular element. In other words, the curvature is such that the connecting portions adhere entirely or almost entirely to the inside wall of the outer tubular element (hence, a curvature that is substantially identical to the outer tubular element). This results in complete (or almost complete) adherence between the connecting portions and the outer tubular element, unlike the solution described above, where the connection is along the tangential zones only.

In this variant embodiment, the intermediate portions create structural continuity between adjacent connecting portions and are preferably defined by reinforcing ribs. This allows increasing the flexural modulus of the straw, compared to the case where the insert is simply circular. The ribs are preferably U- or V-shaped but may also be shaped differently.

In a variant embodiment, the insert has a rectilinear shape. In this variant, the connecting zones are preferably opposite to each other (spaced at 180° from each other).

In a further variant embodiment, the insert is substantially S-shaped and has two connecting zones whose curvature substantially follows the curvature of the outer tubular element. In this variant, the connecting zones may be alternated with a rectilinear or curved intermediate zone.

In an embodiment, the shape of the insert, in transversal cross section, extends along a closed profile. This closed profile may be defined by folding (wrapping or rolling) a sheet or portion of a continuous web so its opposite longitudinal edges are joined together to obtain a closed profile.

In an alternative embodiment, the shape of the insert, in transversal cross section, extends along an open profile. In this situation, therefore, the two opposite longitudinal edges are not brought into contact with each other.

In a first embodiment, the outer tubular element defines a main longitudinal cavity intended for the passage of a liquid or semi-liquid product (hence the straw does not comprise a corresponding inner tubular element concentric with the outer tubular element and the insert extends between at least two distinct portions of the inner surface of the outer tubular element (that is to say, it has two distinct connecting portions) and is positioned in the main cavity of the straw intended for the passage of the liquid or semi-liquid product. In this solution, therefore, the insert is, during use, normally immersed and/or surrounded by the liquid or semi-liquid product.

In a different embodiment, the straw comprises an outer tubular element and an inner tubular element, concentric with each other and defining, between them, an annular chamber in which the insert is placed. Preferably, the insert has outer connecting portions that are fixed to the outer tubular element and/or inner connecting portions that are fixed to the inner tubular element.

Preferably, the insert is made by folding, specifically by transversally folding a continuous web which is then cut.

Preferably, the insert is made in a single body by folding, specifically by transversally folding a continuous web which is then cut.

Preferably, the insert and the outer tubular element are made in a single body (a sheet or portion of a continuous web) by folding, specifically by transversally folding a continuous web which is then cut.

In an alternative embodiment, the insert and the outer tubular element are made separately and connected to each other at a later stage.

Preferably, the connecting portions are connected to the outer tubular element by gluing, preferably using at least one glue selected from: water-based glue (for example, PVA) hot-melt glue, edible glue, biodegradable glue, compostable glue.

According to the invention, the straw is made by wrapping, preferably progressive, an outer layer around an inner preformed layer, the outer layer defining the outer tubular element and the inner layer defining the insert.

A method for making a straw according to the invention, obtained by shaping two separate webs, comprises the following steps:
feeding at least a first continuous web along a first feed path;
feeding at least a second continuous web along at least one respective second feed path (which may be parallel to the first feed path);
folding and/or deforming the first continuous web in such a way as to give the first web a shaped configuration;
after the folding or deforming step, wrapping the second web around the first web having a configuration shaped in such a way as to obtain a continuous tubular element defined by a continuous outer tubular element containing a continuous shaped insert;
cutting the continuous tubular element to obtain a succession of straws.
   In an alternative embodiment, a method for making a straw according to the invention, obtained by shaping a single continuous web, comprises the following steps:
feeding a first portion of a continuous web along a first feed path;
feeding a second portion of the continuous web along a respective second feed path, specifically parallel to, and running alongside, the first feed path;
folding and/or deforming the first portion of the continuous web in such a way as to give the first web a shaped configuration to define an insert;
after the folding or deforming step, wrapping the second portion of the web around the first portion having a configuration shaped in such a way as to obtain a continuous tubular element defined by a continuous outer tubular element containing a continuous shaped insert;
cutting the continuous tubular element to obtain a succession of straws.

Preferably, the step of folding and/or deforming the first web or the first portion of the web is carried out continuously so that the first web or the first portion of the web is deformed while the first web or the first portion of the web advances continuously.

Preferably, the step of folding and/or deforming the first web or the first portion of the web is performed by a first sub-step of deforming the first web or the first portion of the web, preferably a permanent deformation, and a subsequent second sub-step of at least partly wrapping the first web or the first portion of the web about the longitudinal axis, preferably around a spindle to give the first web or the first portion of the web the shaped configuration.

Preferably, the first sub-step is performed by imparting a permanent deformation to the first web or to the first portion of the web through a pair of deformation rollers configured to impress on said first web or on said first portion of the web a transversal succession of longitudinal protrusions or corrugations.

Preferably, also, the step of wrapping the second web or the second portion of the web around the shaped insert comprises, or is preceded by, a step of applying an adhesive substance in a zone of the insert and/or of the second web (or second portion of the web) where the insert and the outer tubular element will come into contact with each other, so as to obtain a straw in which the insert and the outer tubular element are stably connected.

### BRIEF DESCRIPTION OF THE DRAWINGS

The invention is described below with reference to the accompanying drawings, which illustrate a non-limiting embodiment of it and in which:

FIG. 1 shows a food-safe straw according to the invention;

FIG. 1A shows a front view of the straw of FIG. 1;

FIGS. 2-6 are front views of a straw according to other, different embodiments of the invention;

FIG. 7 shows a schematic view of a machine for making a straw according to a first embodiment of the invention;

FIG. 7A is an enlarged view of a detail of the machine of FIG. 7;

FIG. 8 represents a schematic view of a machine for making a straw according to a second embodiment of the invention;

FIG. 9 shows a detail of the machine of FIG. 7 or 8;

FIGS. 10 and 11 are cross sections of a portion of the machine of FIG. 7 or 8 along two successive section planes;

FIG. 12 shows a cross sectional view of the straw of FIG. 1;

FIG. 12A shows an enlarged detail from the view of FIG. 12;

FIG. 13 is a detail view showing a portion of the machine of FIG. 7 or 8;

FIG. 14 schematically represents an operating step carried out in the machine portion of FIG. 13;

FIGS. 15-17 are front views of a straw according to other, different embodiments of the invention.

### DETAILED DESCRIPTION OF PREFERRED EMBODIMENTS OF THE INVENTION

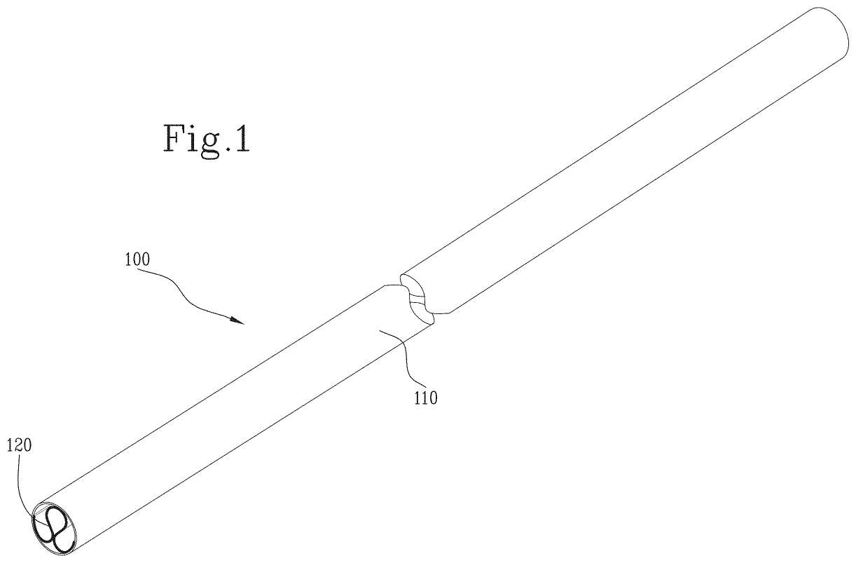

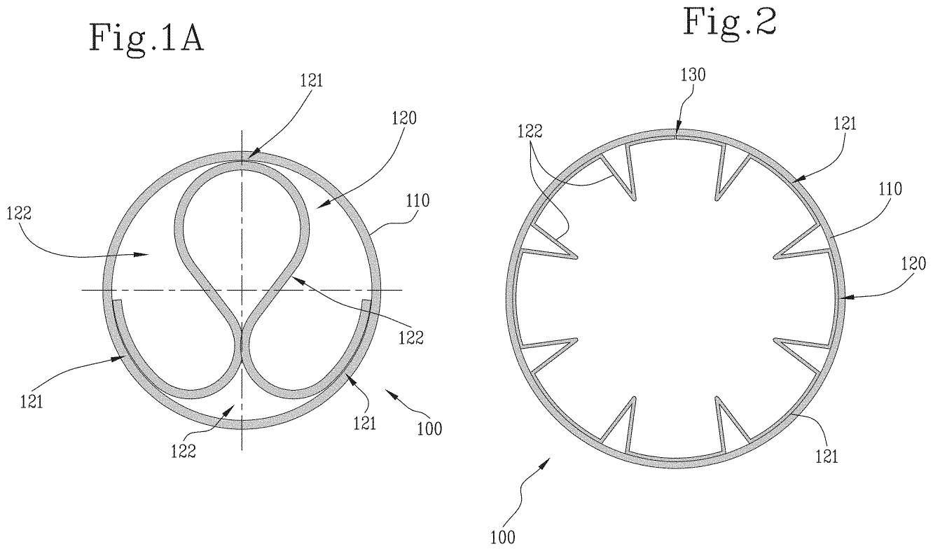

A food-safe straw made according to the invention is illustrated in FIG. 1.

The straw 100 essentially comprises an outer tubular element 110 and an insert 120 placed therein, and extends along a longitudinal axis defining a main direction of extension of the straw 100. The insert 120 extends longitudinally into the outer tubular element 110, preferably for the full length of the straw 100 so that both the outer tubular element 110 and the insert 120 have flush end surfaces.

Preferably, at least one between the outer tubular element 110 and the insert 120 is made of a paper material and, more preferably, both of them are. The paper material may be a single-layer or multilayer material.

According to an aspect of the invention, the insert 120 has a profile whose shape, in transversal cross section, is defined by a line that is at least partly corrugated and/or partly broken in such a way as to increase the bending strength of the straw 100.

In other words, the insert 120 has a three-dimensional shape other than a circular shape so its bending strength is greater than it would be if it had a plain circular shape.

Looking in more detail, in the context of this invention, three-dimensional shapes of the insert 120 may include transversal cross section shapes obtained by a process of elastic and/or permanent deformation of a sheet or web such that the insert 120 has, in transversal cross section, a specifically contoured shape that is visible in the outer tubular element 110 from the outside. The shape is preferably modelled on a geometrical figure or a symbol or a generic shape of varying complexity. By way of non-limiting example, the shape may have a corrugated configuration or it may be the shape of a star or a leaf or a letter of the alphabet (for example, an “S” or an omega, as in FIGS. 1 and 1A) or of a logo (for example, a trademark) or a geometrical figure (square, triangle, rectangle), or a heart or other shape. In the context of this invention, the specific shape does not constitute a limitation of the invention but falls within its scope insofar as the insert 120 adopts a specific shape whose purpose is to increase the bending strength modulus of the straw in at least one direction, preferably in two directions which are transversal or perpendicular to each other. Moreover, the shape of the insert may also be selected with a view to evoking a specific image or emotion in the user.

FIGS. 1 and 1A show a first embodiment in which the shape of the insert 120, in cross section, follows a totally curved, open line.

This shape of the insert 120 defines three connecting zones 121 where it joins the outer tubular element 110 and which correspond to the same number of zones where the insert 120 and the outer tubular element 110 are tangent or similar or identical in curvature. These connecting zones 121 extend for the full length of the straw 100, in particular defining connecting areas or lines.

Preferably, the connecting zones 121 are the sites where an adhesive substance is applied in order to stably, and in particular, irreversibly join the outer tubular element 110 and the insert 120 to each other.

The adhesive substance may comprise at least one glue selected from: water-based glue (for example, PVA) hot-melt glue, edible glue, biodegradable glue, compostable glue.

The connecting zones 121 are angularly distributed around the longitudinal axis of the straw 100 and are spaced from each other by respective intermediate portions 122 that are not connected to the outer tubular element 110. The intermediate zones 122 extend towards the longitudinal axis of the straw, thus defining radial protrusions, directed radially inwards, relative to the connecting portions 121.

In the specific embodiment illustrated in FIGS. 1 and 1A, the connecting portions 121 and the intermediate portions 122 jointly define a single shape with a smooth, curvilinear profile without rectilinear stretches or edges.

Also, in the embodiment of FIGS. 1 and 1A, the intermediate zones 122 define a main portion of the surface of the insert 120, preferably a portion of between 50% and 80% of the surface of the insert 120.

The insert is formed by folding and/or wrapping a single body, specifically a segment or portion of a continuous web.

FIG. 2 shows a variant embodiment in which the insert 120 has a succession of connecting zones 121 whose curvature substantially follows the curvature of the outer tubular element 110 and which are glued to it entirely or almost entirely. The connecting zones 121 preferably lie on a common circle and extend along the full length of the straw 100.

The connecting zones 121 are alternated with respective intermediate zones 122 defining V-shaped, inward facing protrusions whose vertices are pointed towards the longitudinal axis of the straw 100.

In this embodiment, too, the insert may be formed by folding and/or wrapping a single body, specifically a segment or portion of a continuous web. Unlike the embodiment of FIGS. 1 and 1A, the insert 120, in this case, extends along a closed line and its end edges are close together or abutted end to end in a closing zone 130.

Moreover, in this embodiment, it is the connecting zones 121 that define the main portion of the surface of the insert 120, preferably a portion of between 50% and 80% of the surface of the insert 120.

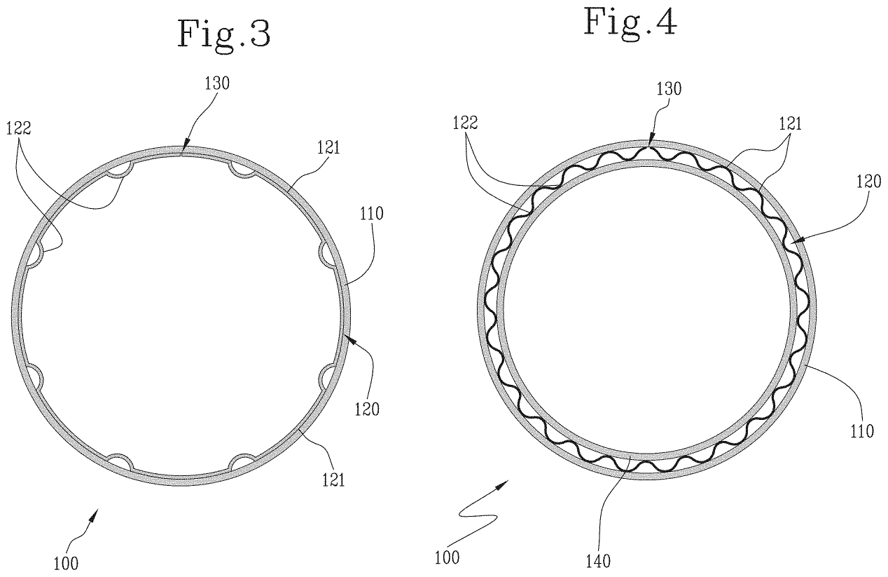

FIG. 3 shows a variant embodiment that differs from FIG. 2 in that the intermediate zones 122 are arcuate, specifically in the shape of circular arcs, with convexity facing towards the longitudinal axis of the straw 100.

More generally speaking, the intermediate portions 122 define longitudinal ribs protruding towards the inside of the straw 100 in order to increase the bending strength of the straw 100 so it is also suitable for mixing liquid or semi-liquid (thick) products.

In a further variant, illustrated in FIG. 4, the insert 120 has, in transversal cross section, a corrugated profile, preferably periodic and symmetrical. The corrugated profile has a succession of top portions, defining the connecting portions 121 connected to the outer tubular element, alternated with bottom portions, facing towards the longitudinal axis of the straw and defining the intermediate portions 122. Preferably, optionally provided is an inner covering layer, or inner tubular element 140, that is stably connected (glued) to the bottom portions and thus defines a circular channel for the passage of the food product.

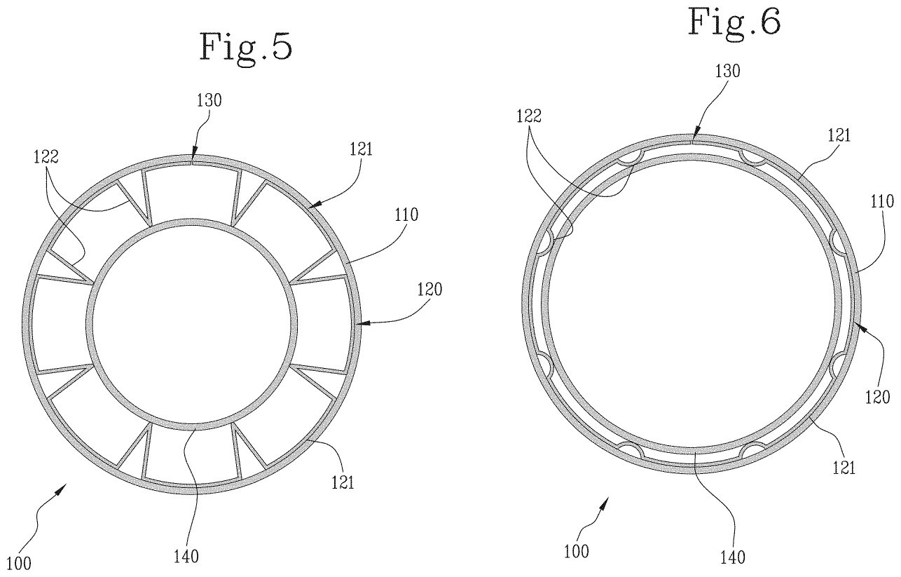

In a yet further possibility, as illustrated in FIGS. 5 and 6, the inner tubular element 140 may, in general, also be provided for the other embodiments, in particular those in which the insert 120 extends along a closed, or substantially closed, line or in any case, along a profile forming a ring-shaped figure. In this situation, the inner tubular element 140 is internally applied and connected to the insert 120, specifically to the intermediate portions 122. That way, the insert 120 remains confined within an annular zone interposed between the outer tubular element 110 and the inner tubular element 140.

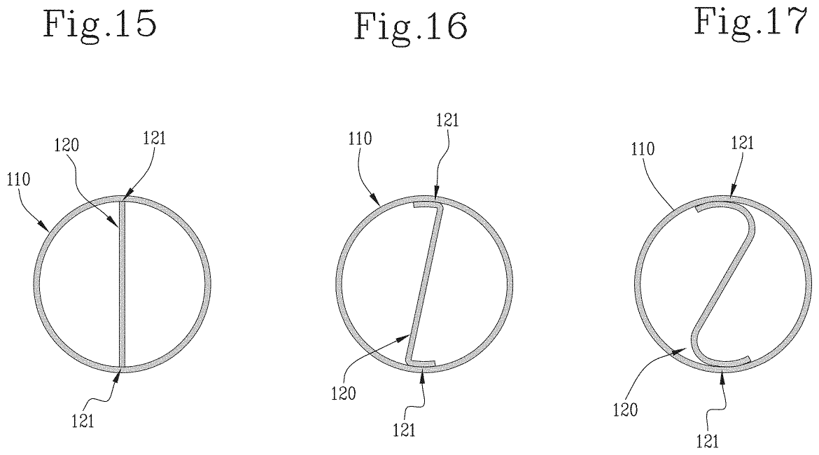

In a further variant embodiment, as illustrated in FIG. 15, the insert 120 has a rectilinear shape and there are two connecting zones 121. These connecting zones 121 are preferably opposite to each other (spaced at 180° from each other).

These connecting zones 121 are alternated with a rectilinear intermediate zone 122.

In a further variant embodiment, as illustrated in FIG. 16, the insert 120 is substantially S-shaped. The insert 120 comprises two connecting zones 121 whose curvature substantially follows the curvature of the outer tubular element 110 and which are glued to it entirely or almost entirely. The connecting zones 121 preferably lie on a common circle and extend along the full length of the straw 100.

The connecting zones 121 are alternated with a rectilinear intermediate zone.

In a further variant embodiment, as illustrated in FIG. 17, the insert 120 is substantially S-shaped. The insert 120 comprises two connecting zones 121 whose curvature substantially follows the curvature of the outer tubular element 110 and are glued to it entirely or almost entirely. The connecting zones 121 preferably lie on a common circle and extend along the full length of the straw 100.

The connecting zones 121 are alternated with curved intermediate zones 122.

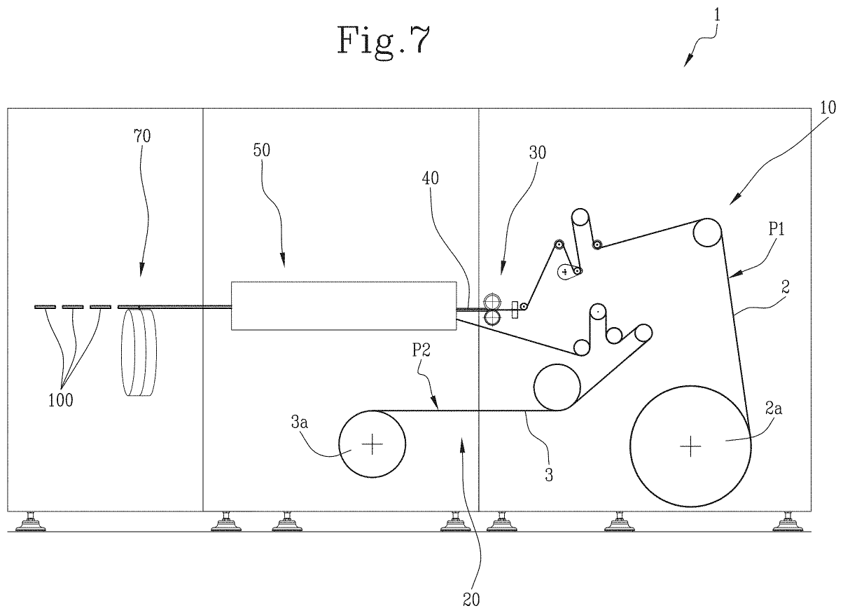

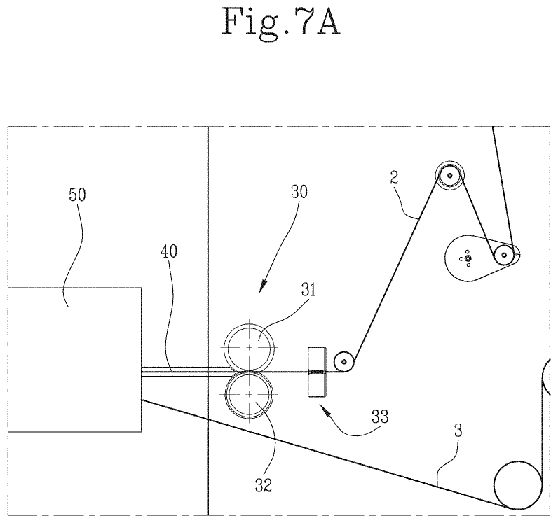

The reference numeral 1 in FIG. 7 denotes in its entirety a machine for making the straw 100 described above, according to a first embodiment of it.

To make the outer tubular element 110 of the insert 120, the machine 1 uses respective continuous webs advancing along respective feed paths and which may be unwound from respective rolls or be obtained by cutting an initially single web longitudinally. However, in a variant embodiment, the outer tubular element 110 and the insert 120 may be obtained by folding, wrapping and/or gathering a single web.

Whatever the case, the main purpose of the machine is to at least partly form first the insert and then wrap the outer tubular element progressively around the insert. More specifically, the insert is a continuous insert and wrapping the outer tubular element occurs progressively to form an outer tubular element that is also continuous before cutting into segments (straws).

The machine 1 of FIG. 7 comprises first feed means 10 for feeding a first continuous web and configured to make at least a first continuous web 2 advance along a first feed path P1 and second feed means 20 for feeding a second continuous web and configured to make a second continuous web 3 advance along at least a respective second feed path P2.

The webs 2, 3 are preferably made of paper and are unwound from respective rolls 2a, 3a, preferably motor-driven.

Preferably, the webs 2, 3, at least in a step of unwinding them from the respective roll 2a, 3a are defined by a single layer.

The machine 1 also comprises a forming station 30, disposed on the first feed path P1 and configured to fold and/or deform the first continuous web 2 in such a way as to obtain a continuous web with a shaped configuration. In other words, the forming station 30 elastically and/or permanently deforms the first web 2 so that the web changes from a flat configuration to a three-dimensional configuration, specifically a laterally gathered configuration, such as to make it suitable for insertion into, thus partly filling, a continuous tube following it.

The forming station is illustrated in detail in FIG. 7A.

Advantageously, the forming station 30 is configured to operate steplessly, thus deforming the first web 2 while the first web 2 advances steplessly.

This is preferably achieved thanks to the structure of the forming station 30, which is configured to make the first web 2 pass uninterruptedly through a forming gap whose transverse cross section is such as to give the first web 2 the above mentioned shaped configuration. Preferably, the forming gap is defined by a slot extending along an open line—that is to say, where the ends of the line along which the forming gap extends are spaced and do not coincide.

In an embodiment, the forming station 30 is configured to deform the first web 2 at least partly elastically. More in detail, that means folding longitudinal portions of the first web 2 relative to each other in such a way as to allow “lateral compacting” or, more generally speaking, “transverse compacting” of the first web 2, but reversibly, so that the first web 2 thus shaped retains a certain elastic tendency to return laterally to its original shape, causing it to adapt to the internal shape of the continuous tube it will next be inserted into.

In this embodiment, the forming gap extends along an open line which is at least partly, and preferably entirely, defined by a succession of curved stretches and specifically by a spline curve. The open line may also have straight stretches—for example, straight stretches alternated with curved stretches or splines—thereby deforming or compacting gently and gradually in order to prevent or limit permanent deformations.

In addition or alternatively to deforming elastically, as just described, the forming station 30 is configured to deform the first web 2 at least partly permanently, specifically to fold the first web 2 about one or more longitudinal fold lines. More in detail, that means permanently deforming certain specific zones of the first web 2, allowing lateral compacting to a greater degree than in the case of purely elastic deformation, as well as repeatedly folding superposed layers. In this last embodiment, the forming gap extends along an open line which has one or more sharp corners defining respective longitudinal fold lines for permanently folding the first web 2.

As mentioned above, the forming station 30 may produce lateral compacting elastically or permanently, or a combination of the two, specifically with elastically deformed zones alternated with permanent fold lines.

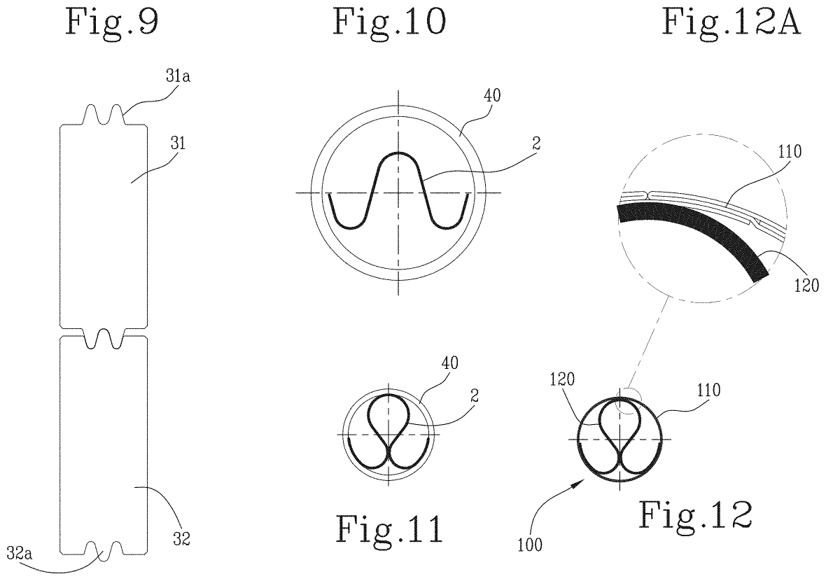

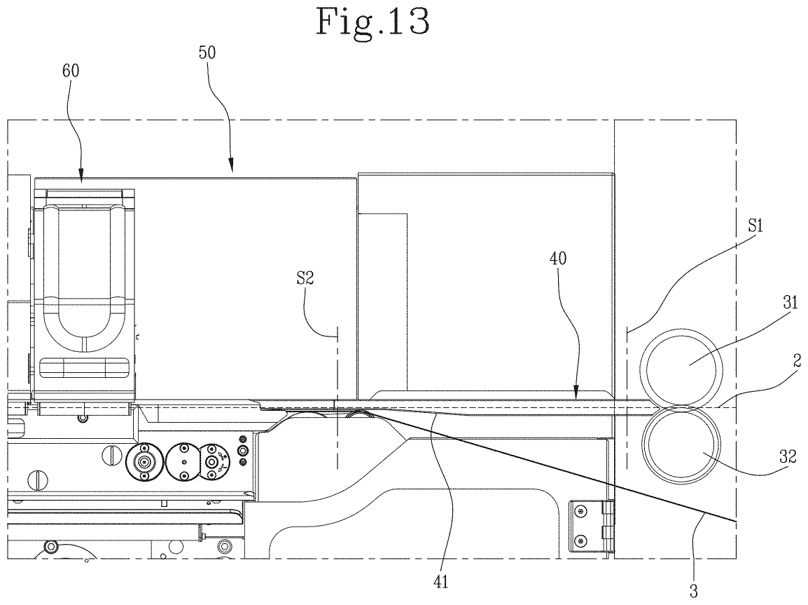

In a preferred embodiment, shown in FIG. 9, the forming station 30 comprises a pair of rollers 31, 32 between which the first web 2 is made to pass and which have respective matchingly shaped external features 31a, 32a (that is to say, whose profiles are shaped to match each other and are thus geometrically compatible) defining the forming gap between them. In other words, the rollers 31, 32, rotatable about parallel axes, have respective peripheral profiles which, in cross section relative to a plane passing through the respective axis, correspond to, and hence are shaped to match, each other so as to define the forming gap of substantially uniform width through which the first web 2 is shaped.

In the embodiment illustrated in FIG. 7, a forming gap of the type described above is also defined by a second forming element, hereinafter called preforming element 33, disposed upstream of the forming rollers 31, 32 and configured to pre-shape the first web 2.

Looking in more detail, the preforming element 33 may be defined by a rigid or monolithic element provided with a fixed forming gap by which the first web 2 undergoes an initial deformation to give the first web 2 a configuration that makes it easier for it to pass through the pair of rollers 31, 32.

In an embodiment not illustrated, the preforming element 33 may even be sufficient to act as a single forming element, in place of the pair of rollers 31, 32.

In a preferred embodiment, the rollers 31, 32 are, instead, structured and/or mounted in such a way as to be held together by a predetermined force such as to compress the first web 2 passing between them. In this configuration, therefore, the size of the forming gap between the rollers 31, 32 is defined by the thickness and compressibility of the first web 2. This advantageously allows giving the rollers 31, 32 not only a function of forming the first web 2 but also of entraining it, where at least one of the two rollers 31, 32 is associated with respective motor means.

Downstream of each of the aforementioned feed means 10, 20 and of the forming station 30, the machine 1 also comprises a tubular guide 40 configured to guide the first web 2 as it leaves the forming station 30 that has given it the shaped configuration and so that it keeps the shaped configuration as it proceeds from the forming station to a wrapping station 50 (described below).

In effect, the passage of the first web 2 through the tubular guide 40 in the shaped configuration allows the first web 2 to keep its shape, contrasting its tendency to return elastically to a laterally expanded configuration.

The tubular guide 40 is shown in detail in FIG. 10.

Preferably, the tubular guide 40 has at least one stretch 41 whose transverse cross section progressively decreases, gradually decreasing in diameter, for example, so as to further compact the shaped first web 2 transversely before it reaches the wrapping station 50, so that the first web 2 that has already been shaped is given the required final transverse cross section.

FIGS. 10 and 11 show cross sections of the tubular guide 40, respectively upstream and downstream of the stretch 41 with the decreasing transverse cross section, specifically at the cross sections S1 and S2 of FIG. 10.

In a preferred embodiment, the tubular guide 40 is made entirely in one piece. It may, however, also be made up of a succession of parts connected to each other to form a single rigid body.

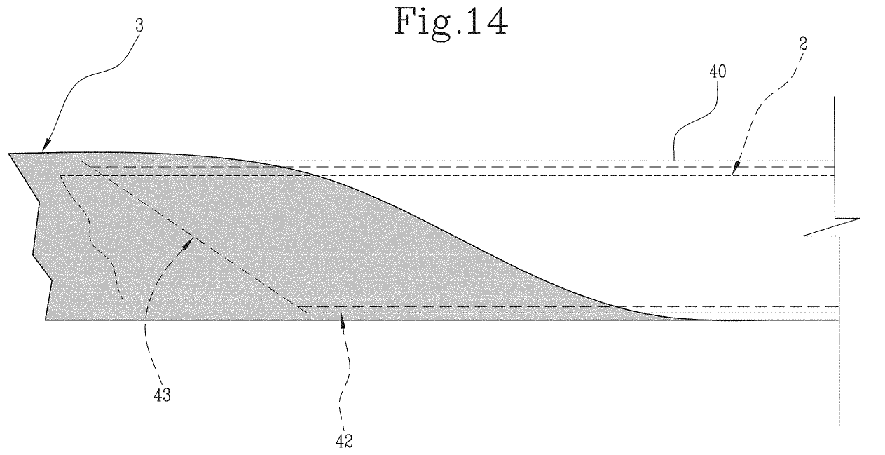

As shown in FIG. 14, the tubular guide 40 has an outlet end portion 42 with an outlet opening 43 lying in an inclined plane not perpendicular to the feed direction of the shaped first web in such a way that the outlet opening 43 faces down.

In a further embodiment not illustrated, the tubular guide 40 may itself be a forming element if the web 2 is not required to adopt a predetermined shaped configuration and has to pass through the tubular guide 40 only.

Downstream of the forming station 30 and of the tubular guide 40, the machine 1 also comprises the aforementioned wrapping station 50, where the first feed path P1 and the second feed path P2 meet and where the second web 3 is wrapped around the previously formed first web having the shaped configuration, thus obtaining a continuous tube defined by an outer covering enclosing within it the first web that has been shaped.

Looking in more detail, the wrapping station 50 is located at the end portion 42 of the tubular guide 40 from which the first web 2 comes out with the shaped configuration and the second web 3 is at least partly wrapped directly round the end portion 42 of the tubular guide 40. Wrapping is accomplished by superposing opposite lateral edges of the second web 3 and gluing them to each other.

The wrapping station preferably also comprises a belt (not illustrated) for guiding the second web 3 driven along a closed path and designed to act in conjunction with fixed deflectors for guiding the second web 3 being wrapped around the end portion 42 of the tubular guide 40.

As shown in FIG. 14, the second web 3, during its initial wrapping movement around the end portion 42 of the tubular guide 40, comes from below and thus the aforementioned outlet opening 43 of the tubular guide 40 faces a central portion of the second web 3 being wrapped around the end portion 42 itself. This advantageously allows exposing a portion of the second web 3 and/or of the shaped first web 2 so that they can be glued to each other to permanently join the shaped first web 2 to the second web 3.

In other words, at least the shaped first web 2 or the second web 3 have to interact with a gluing device 60 along their path in order to spread a layer of glue on at least one of the two webs 2 or 3 so as to join the two webs 2 and 3 to each other.

In a possible embodiment, the end portion 42 of the tubular guide 40 may have the shape of a truncated cone or otherwise tapered in the direction of the continuous tube being formed.

In particular, the gluing device 60, configured to apply an adhesive substance—for example, water-based glue (such as PVA), or hot-melt glue, edible glue, biodegradable glue, compostable glue—on the shaped first web and/or on the second web 3, may be disposed in proximity to the wrapping station 50, and, more specifically, near the outlet opening 43. The gluing device 60 preferably comprises one or more spray nozzles, not illustrated, configured to direct a jet of glue on the shaped first web or on the second web 3.

In embodiments not illustrated, the gluing device may be disposed at a different position: for example, on the first and/or the second feed path P1, P2.

Located downstream of the wrapping station 50 there is a cutting station 70 for dividing the continuous tubular element into a succession of tubular segments 100 defining individual straws 100, specifically between 6 cm and 30 cm in length. The cutting station 70 may comprise a rotary blade of customary type as used, for example, to cut continuous, rod-shaped elements, specifically paper tubes or even continuous cigarette or filter rods, and provided with a rotary drum fitted with one or more radial, preferably adjustable blades.

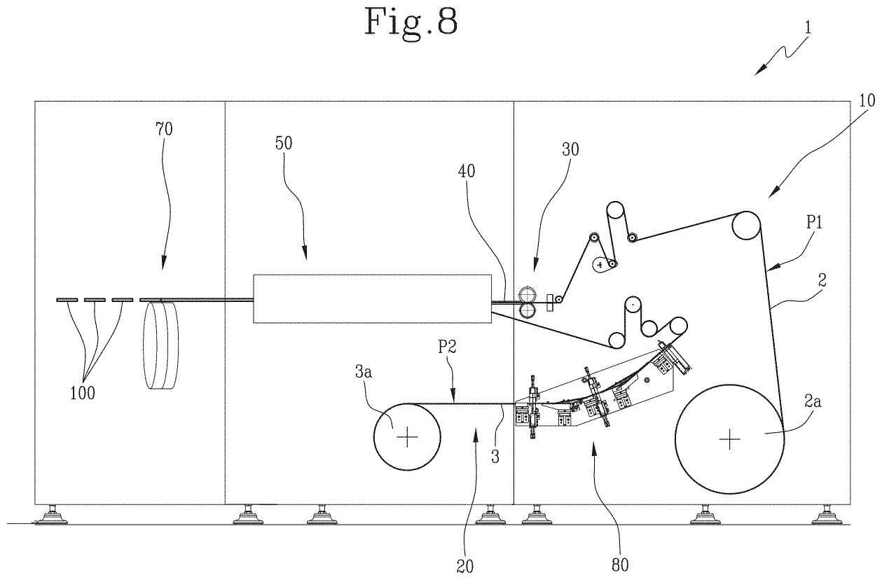

FIG. 8 shows a second embodiment of the machine 1. The machine 1 of this embodiment differs from that of FIG. 7 in that it comprises, on the second feed path P2, upstream of the wrapping station 50, a folding device 80 operating on the second web 3 to fold the second web 3 about two parallel, longitudinal fold lines to give the second web 3 a three-layer structure.

In this situation, the outer tube 110 thus made is visible in the view of FIG. 12 and in the enlarged view of FIG. 12A, showing the splicing zone where the opposite lateral edges of the second, three-layer web 3 are joined.

More generally, the folding device 80 disposed on the second feed path P2 may be configured to fold the second web 3 one or more times about one or more parallel, longitudinal fold lines to give the second web 3 a multilayer structure. Folding in this way is carried out continuously by one or more fixed deflectors having respective folding edges disposed at the respective longitudinal fold line. In order to facilitate folding the second web about the longitudinal fold lines, a scoring device (not illustrated) may be provided on the second feed path P2, upstream of the folding device 80, to make one or more longitudinal lines of weakness that will constitute the fold lines in the folding device 80.

With reference to the embodiment of a straw 100 according to FIGS. 2-6, the machine described above may be substantially the same as that in which the first web 2 is deformed, except for changes in the geometry of the deformation rollers 31, 32 that form the insert 120. In such a case, there is a first sub-step of deforming the first web 2, preferably deforming it permanently, followed by a second sub-step of at least partly wrapping the first web 2 around a longitudinal spindle to give the first web 2 the aforementioned shaped configuration. In this case, on their outside surfaces, the two deformation rollers 31, 32 are provided with a succession of circumferential ridges (on one roller) and corresponding circumferential grooves (on the other roller), respectively V- or U-shaped in cross section, so as to give the first web 2 a transversal succession of longitudinal ridges or corrugations.

This invention is susceptible of modifications without departing from the inventive concept. By way of an example, in the case of a multilayer outer tube, for example with at least two at least partly superposed webs, two or more second webs from respective rolls (or from a single roll cut lengthways to form two webs) and wrapped in such a way as to present respective splicing zones angularly spaced about the axis of the final tubular segment can be used instead of a single second web folded about one or more longitudinal, parallel fold lines.

Furthermore, on the first and/or the second feed path there may be an additional applicator device for applying an additional substance, for example, a flavouring, on the first and/or the second web as they advance before and/or after being formed.

According to a further optional possibility, a creasing and/or scoring device may be provided on the first feed path to make one or more lines of weakness (either continuous or with cyclic interruptions) on the first web to facilitate its subsequent deformation in the forming station. Alternatively, the first web might have these creases and/or scored cuts already made on it when it is unwound from the respective roll.

Moreover, the guide 40 might coincide totally or at least partly with the wrapping station 50, where the outer surface of the guide 40 allows wrapping the second web 3.

The present invention achieves the preset aims, overcoming the disadvantages of the prior art.

In effect, the invention provides a straw which has good recyclability features or, in any case, complies with current regulations on the subject of waste disposal, and which, at the same time, allows obtaining a level of mechanical (bending) strength that allows it to be used for consuming and simultaneously mixing liquid or semi-liquid beverages.

1. A food-safe paper straw, comprising:
an outer tubular element made of paper material which extends along a longitudinal axis;
a longitudinal insert made of paper material positioned inside the outer tubular element and stably connected to an inner surface of the outer tubular element, said insert having a profile, in transversal cross section, defined by a line at least partly corrugated and/or partly broken in such a way as to increase the bending strength of the straw, wherein said insert is stably connected to the inner surface of the outer tubular element in at least two connecting zones, preferably at least three connecting zones, angularly spaced from each other about said longitudinal axis.

2. The straw according to claim 1, wherein said connecting zones are spaced from each other by intermediate portions of the insert extending towards said longitudinal axis.

3. The straw according to claim 2, wherein said connecting zones define a main portion of the surface of the insert, preferably a portion of between 50% and 80% of the surface of the insert.

4. The straw according to claim 2, wherein said intermediate zones define a main portion of the surface of the insert, preferably a portion of between 50% and 80% of the surface of the insert.

5. The straw according to claim 1, wherein the shape of the insert, in transversal cross section, extends along a curved profile preferably without edges and/or rectilinear portions.

6. The straw according to claim 5, wherein said connecting zones are defined by tangential zones between the insert and the outer tubular element.

7. The straw according to claim 1, wherein said insert has a corrugated profile, in transversal cross section, having a succession of top portions, defining said connecting portions, alternated with bottom portions, facing towards said longitudinal axis and defining said intermediate portions; preferably, said straw also comprising an inner covering layer stably connected to said bottom portions.

8. The straw according to claim 2, wherein said connecting portions have a curvature substantially concentric with the outer tubular element.

9. The straw according to claim 2, wherein said intermediate portions are defined by ribs preferably having a “U” or “V” shape.

10. The straw according to claim 1, wherein the insert is made in a single body by folding.

11. The straw according to claim 1, wherein the insert and the outer tubular element are made in a single body by folding.

12. The straw according to claim 1, wherein the shape of the insert, in transversal cross section, extends along a closed profile.

13. The straw according to claim 1, wherein the shape of the insert, in transversal cross section, extends along an open profile.

14. The straw according to claim 1, wherein said connecting portions are connected to the outer tubular element by gluing, preferably using at least one glue selected from: water-based glue, hot-melt glue, edible glue, biodegradable glue, compostable glue.

15. The straw according to claim 1, wherein the insert extends along the longitudinal axis for a length corresponding to the length of the outer tubular element preferably the length being between 6 and 30 cm.

16. The straw according to claim 1, wherein it is made by wrapping, preferably progressive, an outer layer around an inner preformed layer, said outer layer defining the outer tubular element and said inner layer defining the insert.

17. Use of a straw according to claim 1 as a food-safe straw for liquid or semi-liquid products, in particular for sucking and mixing liquid or semi-liquid food products.

18. A method for making a food-safe straw according to claim 1, comprising the steps of:
feeding at least a first continuous web or a first portion of a continuous web along a first feed path;
feeding at least a second continuous web or a second portion of a continuous web along a respective second feed path;
folding and/or deforming the first continuous web or the first portion of the continuous web in such a way as to give the first web or the first portion of the continuous web a shaped configuration;
after the folding or deforming step, wrapping said second web or said second portion of the web about said first web or said first portion of the web having a configuration shaped in such a way as a continuous tubular element defined to obtain a continuous outer tubular element containing a continuous shaped insert;
cutting the continuous tubular element to obtain a succession of straws.

19. The method according to claim 18, wherein the step of folding and/or deforming the first web or the first portion of the web is carried out continuously so that the first web or the first portion of the web is deformed while the first web or the first portion of the web advances continuously.

20. The method according to claim 18, wherein said step of folding and/or deforming the first web or the first portion of the web is performed by a first sub-step of deforming the first web or the first portion of the web, preferably a permanent deformation, and a subsequent second sub-step of at least partly wrapping the first web or the first portion of the web around a spindle to give the first web or the first portion of the web said shaped configuration.

21. The method according to claim 20, wherein said first sub-step is performed by imparting a permanent deformation of the first web or of the first portion of the web through a pair of deformation rollers configured to impress on said first web or on said first portion of the web a transversal succession of longitudinal protrusions or corrugations.
